(19) United States
(12) Patent Application Publication
(10) Pub. No.: US 2015/0269918 A1
(43) Pub. Date: Sep. 24, 2015

(54) NECK OF WOODWIND INSTRUMENT AND WOODWIND INSTRUMENT USING THE SAME

(71) Applicant: CHIN-MEI WANG, Changhua County (TW)

(72) Inventor: CHIN-MEI WANG, Changhua County (TW)

(21) Appl. No.: 14/219,804

(22) Filed: Mar. 19, 2014

(51) Int. Cl. G10D 7/08

(52) U.S. Cl. CPC G10D 7/08

(57) ABSTRACT

The present invention provides a neck for a woodwind instrument, such as saxophone. The neck has a connection assembly at the bottom end thereof whose density is lower than that of the other portion of the neck. The connection assembly is adapted for the body of the woodwind instrument to connect thereto. As such, energy loss of vibration transmitted between the neck and the body of the woodwind instrument is minimized. Resonance and volume of the instrument are improved without changing the appearance of the instrument.

### BACKGROUND OF THE INVENTION

1. Field of the Invention

The present invention relates to a woodwind instrument, such as saxophone.

2. Description of the Prior Art

Conventional woodwind instrument, such as saxophone disclosed in U.S. Pat. No. 6,476,302 B1 or U.S. Pat. App. No. 2007/0277666A1, includes mouthpiece, neck, and body. The mouthpiece is equipped with a reed. The body has a keystroke system and octave vents. The neck is detachably connected between the mouthpiece and the body.

The detail structure of the neck is described in U.S. Pat. No. 6,143,969 and TW Pat. No. 1383374. The front end of the neck is provided with a mouthpiece connecting tube or adapter. The mouthpiece connecting tube has cork at the outer surface thereof, so that the mouthpiece can be sleeved on the mouthpiece connecting tube directly. The rear end of the neck is provided with a body adapter for the body to be connected thereto.

The body and the neck of saxophone are usually made by copper or copper alloy, such as brass or white copper. Instruments can provide different timbre with different materials. Thus, user may choose an instrument with a certain material for a preferred timbre.

### SUMMARY OF THE INVENTION

The progression of instrument is always seeking for various possibilities of timbre and stronger resonance and volume. Thus, user can play effortlessly with a suitable volume. The main object of the present invention is trying to find a way to improve or to specialize the performance of an instrument in timbre or resonance.

To achieve the above and other objects, the present invention provides a woodwind instrument. The woodwind instrument includes a tubular main body and a connection assembly. The main body has a first end and a second end. The connection assembly includes a connection tube and a ligation ring. The connection tube is firmly disposed at the second end. The connection tube is adapted to be sleeved in a body of the woodwind instrument. The ligation ring is adapted for sleeving on the body of the woodwind instrument for tightening the body of the woodwind instrument and the connection tube. Density of at least one of the connection tube and the ligation ring is lower than density of the main body.

The connection tube may be firmly disposed at the second end by soldering, welding, gluing, wedging, threading, or interference fit jointing. The material of the main body may be copper or copper alloy. The material of the connection tube and the ligation ring may be aluminum, aluminum alloy, magnesium, magnesium alloy, polymer, carbon fiber reinforced plastic, or glass fiber reinforced plastic.

In some cases, the connection tube may include a fixation subsection and a connection subsection. The fixation subsection and the connection subsection are respectively located at two ends of the connection tube. The fixation subsection sleeves on and connect rigidly to the second end of the main body. The connection subsection has an appearance configured for the body of the woodwind instrument to sleeve thereon. The neck may further include a mouthpiece connecting tube. The mouthpiece connecting tube is firmly disposed at the first end. The main body may be formed with a vent and a curved subsection. The curved subsection is located between the vent and the second end. The diameter of the second end of the main body is larger than the diameter of the first end of the main body. The neck may further include a keystroke structure. The keystroke structure is pivotably disposed on the main body so as to open or cover the vent.

Accordingly, the neck of the present invention is provided for woodwind instrument. By the connection assembly which has a lowered density, the neck connects the mouthpiece to the body of the woodwind instrument. When user plays the instrument, vibration transmits from component to component. The density lowered connection assembly can reduce energy loss of the vibration transmission. As such, amplitude of the vibration is maintained. Resonance and volume of the instrument are improved. In addition, the main body of the neck can still be made by the same material of the body of the instrument. The instrument can keep the ordinary traditional appearance consistently. Therefore, performance is improved without changing the appearance of the instrument.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial breakdown drawing showing a first embodiment of the present invention;

FIG. 2 is a partial profile showing a first embodiment of the present invention;

FIG. 3 is a stereogram showing a first embodiment of the present invention;

FIG. 4 is a partial enlargement of FIG. 3.

### DETAILED DESCRIPTION OF THE PREFERRED EMBODIMENTS

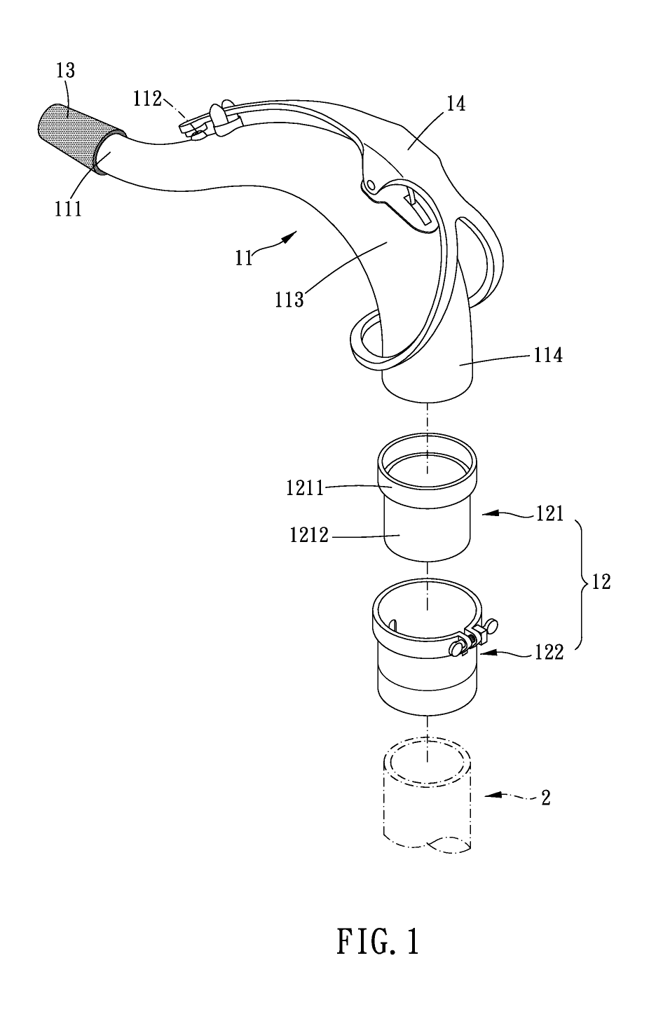

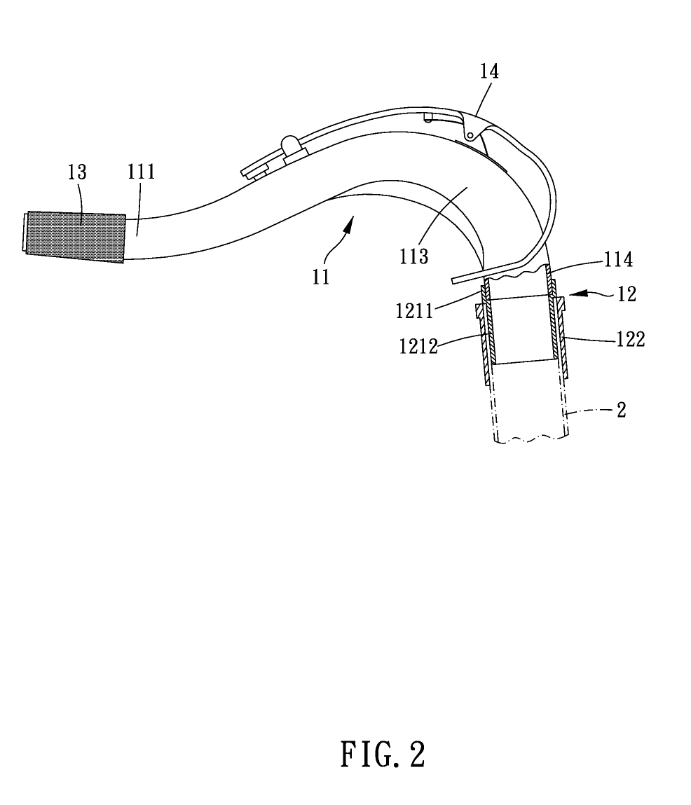

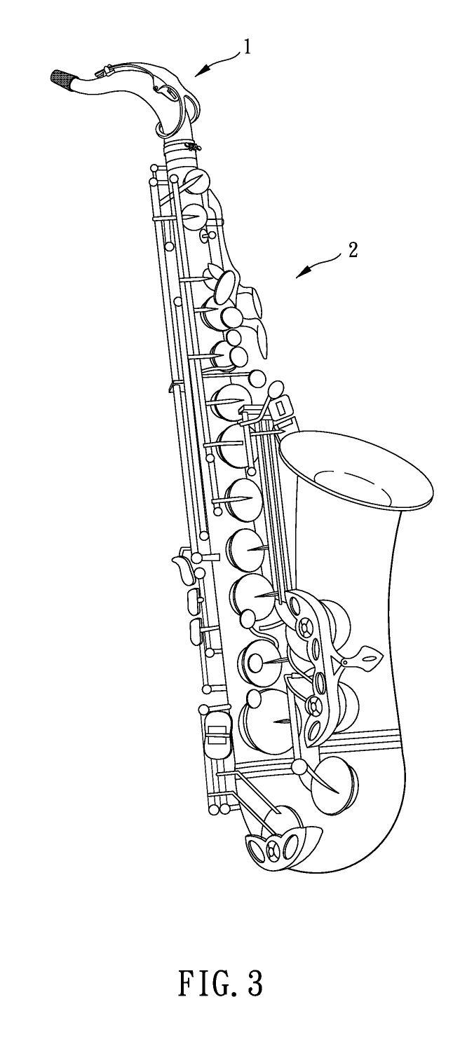

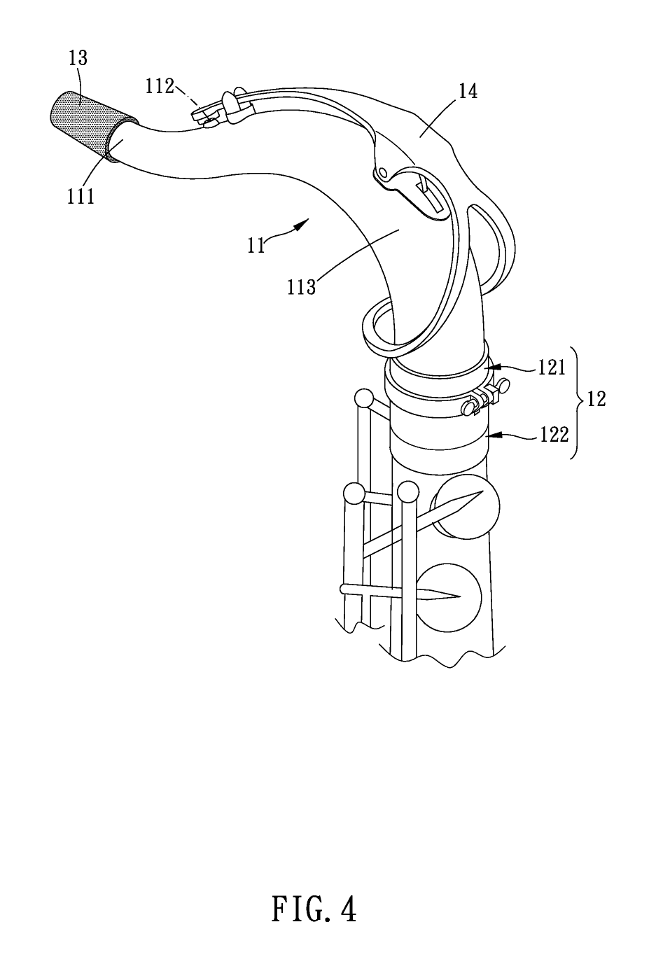

Please refer to FIG. 1 and FIG. 2 for a first embodiment of the present invention. The present embodiment provides a neck of woodwind instrument for being assembled in a saxophone, as shown in FIG. 3 and FIG. 4. The neck can be installed on the top end of the body 2 of the saxophone. The top end of the neck can be installed with a mouthpiece for playing the saxophone. Saxophone, the taken example of woodwind instrument, is generally made by copper. However, by developing of the material and manufacturing technology, the neck is possible to be used in saxophones which is made by polymer or other material or in other woodwind instrument.

As shown in FIG. 1 and FIG. 2, the neck of the present embodiment includes a main body 11, a connection assembly 12, a mouthpiece connecting tube 13, and a keystroke structure 14. The main body is a curved tube, having a first end 111, a vent 112, a curved subsection 114, and a second end 114 which are serially connected. The main body is gradually enlarged from the first end 111 toward the second end 114, so that the diameter of the second end 114 is larger that the diameter of the first end 111. The material of the main body 11 is copper or copper alloy, such as brass or white copper. However, the main body is still possible to be made by polymer of other material. In addition, nickel, silver, or other metal may be plated on the main body, or the main body may be painted or be treated by other surface treatment. However, in these cases, the body of the saxophone is usually made by the same material and plated by the same metal or treated by the same treatment. To be more specifically, the main body 11 may be made by the same manufacturing method as described in TW Pat. No. 1383374.

The connection assembly 12 includes a connection tube 121 and a ligation ring 122. The connection tube 121 is firmly disposed on the second end 114 of the main body 11. The connection tube 121 is adapted to be sleeved in the body 2 of the woodwind instrument. The ligation ring 122 sleeves on the body 2 of the woodwind instrument for tightening the body 2 of the woodwind instrument and the connection tube 121. The density of at least one of the connection tube 121 and the ligation ring 122 is lower than density of the main body 11. More specifically, the connection tube 121 includes a fixation subsection 1211 and a connection subsection 1212. The fixation subsection 1211 and the connection subsection 1212 are respectively located at two ends of the connection tube 121. The diameter of the fixation subsection 1211 is slightly larger than the diameter of the second end 114 of the main body 11. Thus, the fixation subsection 1211 can be sleeved on and soldered to the second end 114 of the main body 11. The fixation subsection 1211 is then connected rigidly to the second end 114 of the main body 11. In preferred embodiments, the connection subsection has a predetermined inner diameter, such that the neck has a smooth overall inner surface after the connection tube is rigidly connected to the main body. In other possible embodiments of the present invention, the connection tube may be firmly disposed at the second end of the main body by welding, gluing, wedging, threading, or interference fit jointing. The connection subsection 1212 has an appearance configured for another tube to sleeve thereon. More specifically, the connection subsection 1212 has a cylindrical outer surface, so that the connection subsection 1212 of the connection tube 121 has a straight tubular appearance. The body of the saxophone can sleeve on the connection subsection 1212, as shown in FIG. 3 and FIG. 4. However, the connection subsection may have prismatical appearance with noncircular cross-section as long as the connection subsection can be sleeved or fitted in the body of the saxophone. The connection tube 121 is made by different material from the main body 11, and the density of the connection tube 121 is lower than that of the main body 11. More specifically, the connection tube 121 may be made by aluminum, aluminum alloy, magnesium, magnesium alloy, polymer, carbon fiber reinforced plastic, or glass fiber reinforced plastic. The connection tube 121 may be further treated by heat treatment for manufacturing purpose or obtaining higher strength. The ligation ring 122 is a radially shrinkable or expandable structure (such as C ring, a ring with a gap). The ligation ring 122 may be made by aluminum, aluminum alloy, magnesium, magnesium alloy, polymer, carbon fiber reinforced plastic, or glass fiber reinforced plastic. It is noted that in the neck 1, the lower density portion whose density is lower than the density of the main body 11 could be only the connection tube 121, only the ligation ring 122, or both the connection tube 121 and the ligation ring 122.

The mouthpiece connecting tube 13 is firmly disposed at the first end 111, provided for the mouthpiece of the saxophone to sleeve thereon. To be more specifically, the mouthpiece connecting tube 13 is a cork tube, sleeving on and being glued to the first end 111 of the main body 11. The mouthpiece connecting tube 13 is then unable to be detached from the first end 111. In other possible embodiments of the present invention, the mouthpiece connecting tube may be a metal tube or tube made by other material whose outer surface is covered by cork disposed firmly thereon. The tube is further firmly disposed at the first end of the main body by soldering, welding, gluing, wedging, threading, or interference fit jointing, such as the mouthpiece connecting tube described in TW Pat. No. 1383374.

The keystroke structure 14 is pivotably disposed on the main body 11 so as to open or cover the vent 112. More specifically, one end of the keystroke structure 14 extends to the second end 114 of the main body. The other end of the keystroke structure 14 extends to the vent 112. Thus, the keystroke structure 14 may be pushed or pressed by the keystroke system of the saxophone to pivot between a position covering the vent 112 and another position opening the vent 112. In some possible embodiments of the present invention, the vent and the keystroke structure may be dismissed, especially when the neck is utilized in baritone saxophone or bass saxophone.

Accordingly, the neck is provided for being installed on the top end of the body of the saxophone, as shown in FIG. 3 and FIG. 4. A mouthpiece may be installed on the top end of the neck. Thus, the neck connects the mouthpiece to the body. The neck has a connection tube and a ligation ring which are used to connect with the body of the saxophone. The connection tube and the ligation ring have lowered density. Thus, vibration is efficiently transmitted between the neck and the body when a user plays the saxophone. Energy loss of vibration transmission between the components is minimized. Resonance and volume of the saxophone are then maintained or improved. The difficulties of playing the saxophone are reduced. User can play the saxophone with tensional performance easily.

In addition, the connection subsection of the connection tube would be covered without exposure by the body in using. The main body of the neck can be made by the original material. The material of the main body of the neck may be selected as the same material of the body of the saxophone. Thus, user can choose the material he/she is familiar with, such as cooper saxophone or brass saxophone. Uniform appearance of the saxophone can be maintained, especially in color of the neck and the body.

Based on the embodiments mentioned above, the neck of the present invention may be further adjusted by material or structure. The connection tube and the ligation ring may be made by aluminum, aluminum alloy, magnesium, magnesium alloy, polymer, carbon fiber reinforced plastic, or glass fiber reinforced plastic, or by other polymer which has higher hardness, lower density, or higher stiffness than the material of the main body. In addition, using different materials at neck and body of the saxophone is still possible. For example, copper body can still be assembled with silver neck or magnesium alloy neck. For appearance or resonance purpose, the neck and the body may be treated with different colors. For instance, body with gold paint may be assembled with silver plated neck.

To conclude, the neck has a connection assembly whose density is lower than the main body of the neck. The connection assembly is used for connecting the neck to the body of the woodwind instrument. Thus, energy loss of vibration transmission between the neck and the body is reduced. Resonance and volume of the instrument are improved without changing the appearance of the instrument.

What is claimed is:

1. A neck of woodwind instrument, characterized in that: the neck comprises a tubular main body and a connection assembly, the main body has a first end and a second end, the connection assembly comprises a connection tube and a ligation ring, the connection tube is firmly disposed at the second end, the connection tube is adapted to be sleeved in a body of the woodwind instrument, the ligation ring is adapted for sleeving on the body of the woodwind instrument for tightening the body of the woodwind instrument and the connection tube, density of at least one of the connection tube and the ligation ring is lower than density of the main body.

2. The neck of woodwind instrument of claim 1, wherein the connection tube is firmly disposed at the second end by soldering, welding, gluing, wedging, threading, or interference fit jointing.

3. The neck of woodwind instrument of claim 1, wherein material of the main body is copper or copper alloy, material of the connection tube is aluminum, aluminum alloy, magnesium, magnesium alloy, polymer, carbon fiber reinforced plastic, or glass fiber reinforced plastic.

4. The neck of woodwind instrument of claim 1, wherein material of the main body is copper or copper alloy, material of the ligation ring is aluminum, aluminum alloy, magnesium, magnesium alloy, polymer, carbon fiber reinforced plastic, or glass fiber reinforced plastic.

5. The neck of woodwind instrument of claim 1, wherein the connection tube comprises a fixation subsection and a connection subsection, the fixation subsection and the connection subsection are respectively located at two ends of the connection tube, the fixation subsection sleeves on and connects rigidly to the second end of the main body, the connection subsection has an appearance configured for the body of the woodwind instrument to sleeve thereon.

6. The neck of woodwind instrument of claim 1, wherein the neck further comprises a mouthpiece connecting tube which is firmly disposed at the first end.

7. The neck of woodwind instrument of claim 1, wherein the main body has a vent and a curved subsection, the curved subsection is located between the vent and the second end, diameter of the second end of the main body is larger than diameter of the first end of the main body.

8. The neck of woodwind instrument of claim 7, wherein the neck further comprises a keystroke structure, the keystroke structure is pivotably disposed on the main body so as to open or cover the vent.

9. The neck of woodwind instrument of claim 1, wherein the woodwind instrument is saxophone.

10. A woodwind instrument, characterized in that the woodwind instrument comprises the neck of woodwind instrument of claim 1.
